(19) United States
(12) Patent Application Publication
(10) Pub. No.: US 2012/0259571 A1
(43) Pub. Date: Oct. 11, 2012

(54) IQ CALIBRATION METHOD OF TEST DEVICE FOR WIRELESS COMMUNICATION SYSTEM SUCH AS DVB-H SYSTEM OR LIKE, DEVICE, AND TEST DEVICE MANUFACTURING METHOD

(75) Inventors: Myoung Koo Kang, Suwon-si (KR); Chang Bok Yang, Yongin si (KR); Jong Min Kim, Seongnam-si (KR); Jin Soup Joung, Seongnam-si (KR)

(73) Assignee: INNOWIRELESS CO., LTD., Seongnam-si (KR)

(21) Appl. No.: 13/518,538

(22) PCT Filed: Dec. 24, 2009
(86) PCT No.: PCT/KR2009/007798

§ 371 Date: Jun. 22, 2012

(30) Foreign Application Priority Data
Dec. 23, 2009 (KR) 10-2009-0130095

(51) Int. Cl. G06F 19/00

(52) U.S. Cl. 702/85

(57) ABSTRACT

The present invention relates to an automatic calibration method of a test device for testing a wireless communication system such as a DVB-H or the like, a device, and a manufacturing method thereof, and more specifically, to a calibration method and device for providing an automatic calibration data generation function, in which the same frequency characteristic of the test device is maintained in various frequency bands and the test device is capable of generating an exact and reliable test signal. The calibration method of the present invention comprises the steps of: (a) extracting the size of a removal target signal component on the basis of a calibration signal generated from the test device; (b) extracting a change value of the size of the removal target signal component; (c) adjusting at least one calibration parameter on the basis of the change value, and transmitting an adjusted calibration parameter value to the test device, and calculating a calibration parameter value which minimizes the size of the removal target signal component, and generating the calculated value as calibration data, by repeatedly performing the steps (a) to (c).

### TECHNICAL FIELD

The present invention relates to a method and an apparatus for automatically calibrating a test device for testing a wireless communication system such as a DVB-H system and the like, and a method of manufacturing the test device. More particularly, the present invention relates to a calibration method and a calibration apparatus for providing a function of automatically generating calibration data, which enables a test device to maintain the same frequency characteristics in various frequency bands and to generate an accurate and reliable test signal.

### BACKGROUND ART

A DVB-H system refers to a technology standard defining a standard of a broadcasting service of a mobile handset as one of digital broadcasting standards of a mobile TV. The DVB-H system defines additional requirements for a handheld device in DVB-T which is a terrestrial digital broadcasting standard. The DVB-H was adopted as a European official standard in 2004, and its detailed matters are defined in ETSI EN 302 304. The DVB-H was approved as an excellent technology of a terrestrial mobile broadcasting by the European Union in 2008. Meanwhile, introductions of DVB-SH and DVB-H2 are considered to improve the spectral efficiency and the flexibility of modulation of the DVB-H.

In general, a test device or a measurement device of a communication system should satisfy various items based on purposes of the test by a user. As the communication system becomes gradually complicated and advanced, the test device for testing the capability of the communication system is also required to have the capability for accurately and reliably testing the capability of the communication system and a function of measuring various test items for the communication system.

Further, in order to enable a measurement result of various test items to have higher reliability, the same frequency characteristics should be maintained in various frequency bands.

FIG. 1 is a block diagram of a test device for testing the capability of the conventional DVB-H system.

As shown in FIG. 1, the test device 100 includes a baseband signal generator 110 for generating an I mode baseband signal and a Q mode baseband signal, a carrier output unit 120 for outputting a carrier for modulating the I and Q mode baseband signals, and a test signal generator 130 for generating a test signal by combining the I and Q mode baseband signals and the carrier.

When a test signal of the test device 100 transmitted to the DVB-H system in order to test the capability of the DVB-H system is modulated under an ideal condition, the reliability of a test result of the capability may be guaranteed. However, since characteristics of a device used for each test device 100 in manufacturing the test device 100 are different from each other and the baseband signal generator 110, the carrier output unit 120, and the test signal generator 130 are not ideally combined, the reliability of the test signal output from the test device 100 is not sufficiently guaranteed and also a different test result is provided by each manufactured test device.

Particularly, in IQ modulation, various causes such as a gain difference between an I mode signal and a Q mode signal, a carrier leakage generated around a modulator, a phase error and the like become main causes of capability deterioration of the test device 100.

Accordingly, in order to enable the manufactured test device to have the reliable capability, a calibration process such as a gain calibration of the I and Q mode baseband signals, an I offset, a Q offset and the like in consideration of characteristics of each manufacturing apparatus is required.

Meanwhile, the test device for the wireless communication system should maintain the same frequency characteristics in various frequency bands in order to further improve the capability. To this end, the calibration process should be performed in a wide frequency band.

However, it is realistically impossible for a user to perform the calibration one by one in the wide frequency band.

### DISCLOSURE

### Technical Problem

The present invention has been made to solve the above-mentioned problem, and an aspect of the present invention is to provide a calibration method of securing the reliability of a test device for testing the capability of a digital broadcasting reception apparatus.

Also, another aspect of the present invention is to provide an automatic calibration method which can automatically and quickly calibrating the test device for entire frequency bands such that the same characteristics are maintained for each frequency band in various frequency bands.

### Technical solution

In accordance with an aspect of the present invention, there is provided a method of calibrating a test device for a wireless communication system performed by a calibration apparatus, the method including the steps of: (a) extracting a size of a target signal component of removal based on a signal for a calibration generated in the test device; (b) extracting a changed value of the size of the target signal component of removal; (c) controlling one or more calibration parameters based on the changed value and transmitting values of the controlled calibration parameters to the test device; and calculating a calibration parameter value minimizing the size of the target signal component of removal through repetition of the steps of (a) to (c), and generating the calculated calibration parameter value as calibration data.

The step of (a) may include directly extracting the size of the target signal component of removal from the signal for the calibration by receiving the signal for the calibration generated in the test device, or extracting the size of the target signal component of removal from an analysis signal transmitted by a signal analyzing device receiving the signal for the calibration generated in the test device.

The target signal component of removal may include a signal component due to carrier leakage or a spurious signal component and the size of the target signal component of removal includes a size of the signal component due to the carrier leakage or a size of the spurious signal component, wherein minimizing the size of the target signal component of removal corresponds to minimizing the size of the signal component due to carrier leakage or the size of the spurious signal component.

The method may further include generating the calibration data for each frequency by repeatedly performing the calibration in every predetermined frequency unit for entire frequency bands related to a test of the test device, and transmitting the generated calibration data for each frequency to the test device.

The calibration may include an IQ calibration, and the calibration parameter includes two or more parameters of a gain control parameter of an I mode signal, a gain control parameter of a Q mode signal, a phase angle control parameter of a baseband signal, an offset control parameter of the I mode signal, and an offset control parameter of the Q mode signal.

The wireless communication system may be a DVB-H system, and the calibration is an IQ calibration.

The step of (c) may include determining whether the size of the target signal component of removal arrives within an approximate value of an expected minimum value; deciding an increase/decrease direction of the calibration parameter as a direction in which the size of the target signal component of removal is decreased, based on the changed value; and increasing or decreasing the calibration parameter according to the decided increase/decrease direction for each predetermined unit, wherein, when the size of the target signal component of removal arrives within the approximate value of the expected minimum value, an increase/decrease unit of the calibration parameter is reduced so that a precise control of the calibration parameter is achieved.

Minimizing the target signal component of removal may include minimizing the spurious signal component by controlling an offset control parameter of an I mode signal and an offset control parameter of a Q mode signal and then minimizing a signal component due to carrier leakage by controlling a gain control parameter of the I mode signal, a gain control parameter of the Q mode signal, and a phase angle control parameter of an IQ baseband signal.

In accordance with another aspect of the present invention, there is provided a test device for a wireless communication system, the test device including a test signal generator for generating a signal for a calibration used for calibration of the test device and a capability test signal used for testing capability of the wireless communication system; a communication unit for transmitting the signals generated by the test signal generator to an outside and receiving calibration data calculated for each predetermined frequency; a storage unit for storing the calibration data; and a calibration controller for calibrating the test signal generator by using the calibration data.

The test signal generator may include a baseband signal generator for generating an I mode signal and a Q mode signal; and a test signal modulator for generating a test signal for calibration by modulating the I mode signal and the Q mode signal.

The calibration controller may include a calibration parameter extractor for extracting a calibration parameter for a corresponding frequency from the stored calibration data; a gain controller for controlling a gain of the I mode signal and a gain of the Q mode signal by using the extracted calibration parameter; and an offset controller for controlling an offset of the I mode signal and an offset of the Q mode signal by using the extracted calibration parameter.

The wireless communication system may be a DVB-H reception apparatus.

In accordance with another aspect of the present invention, there is provided a method of manufacturing a test device capable of performing a calibration for each corresponding frequency, the method including the steps of: manufacturing a test device; (a) generating a signal for a calibration by using the test device, and transmitting the generated signal to a calibration apparatus; generating calibration data by using the calibration apparatus; and storing the calibration data in the test device to optimize the test device.

Generating of the calibration data may includes the steps of: (b) extracting a size of a target signal component of removal from the signal for the calibration generated in the test device by using the calibration apparatus; (c) extracting a changed value of the size of the target signal component of removal by using the calibration apparatus; (d) controlling one or more calibration parameters based on the changed value, and transmitting values of the controlled calibration parameters to the test device; and calculating a calibration parameter value optimizing the size of the target signal component of removal, by using the calibration apparatus and the test device through repetition of the steps of (a) to (d), and generating the calculated calibration parameter value as calibration data.

### Advantageous Effects

According to the present invention, there is an effect of securing the reliability of the test device for testing the capability of a digital broadcasting receiving apparatus by providing the test device in which the calibration performed for each of various frequency bands so that the same frequency characteristics are maintained in various frequency bands.

Also, there is an effect of quickly and precisely performing an amount of calibration which cannot be performed manually, by providing a method of automatically performing the calibration by a computer apparatus calculating calibration data for each frequency band.

### BRIEF DESCRIPTION OF THE DRAWINGS

FIG. 1 is a block diagram of a test device for testing capability of the conventional DVB-H system.

FIG. 2 illustrates a test device including an IQ modulator according to an embodiment of the present invention.

FIG. 3 illustrates a calibration system of the test device for the DVB-H system according to another embodiment of the present invention.

FIG. 4 illustrates a test device according to an embodiment of the present invention.

FIG. 5 illustrates a detailed construction of a test device according to an embodiment of the present invention.

FIG. 6 illustrates a test signal generated by an ideal modulator.

FIG. 7 illustrates a signal for the calibration generated in a test device to calibrate the test device.

FIG. 8 illustrates an embodiment of a GUI of an automatic calibration program installed in a calibration apparatus.

FIGS. 9 and 10 illustrate the calibration performed by receiving a signal for the calibration.

FIG. 11 illustrates a change in a target signal component of removal based on a control of a calibration parameter.

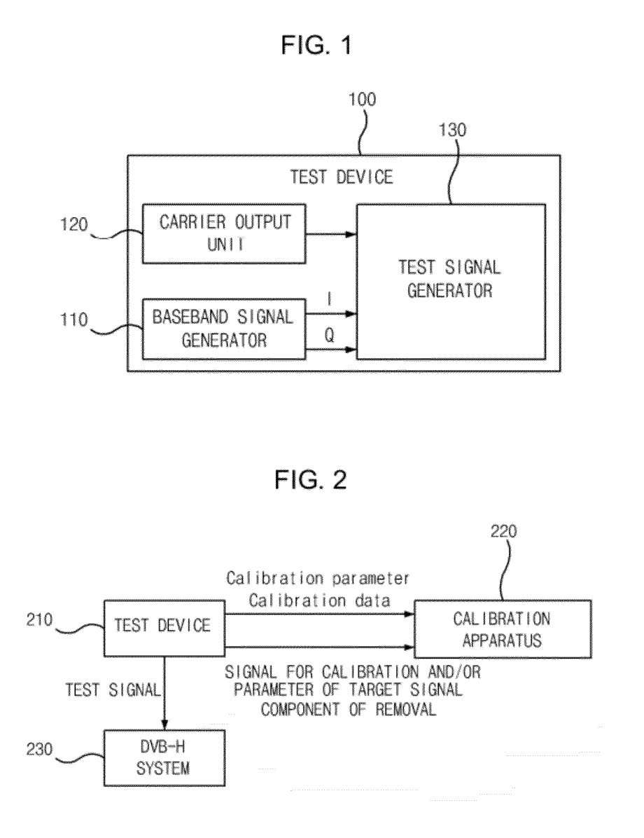

### MODE FOR CARRYING OUT THE INVENTION

The above and other aspects, features and advantages of the present invention will be more apparent from the following detailed description taken in conjunction with the accompanying drawings. Hereinafter, exemplary embodiments of the present invention will be described with reference to accompanying drawings in detail so that those skilled in the art may easily implement the present invention.

FIG. 2 illustrates a test device including an IQ modulator according to an embodiment of the present invention.

As shown in FIG. 2, a calibration system may include a test device 210 for testing a capability of a DVB-H reception apparatus, a calibration apparatus 220 for calibrating the test device 210, and a DVB-H system 230.

The test device 210 has a signal generating module for generating a test signal. It is preferable that the signal generating module includes a baseband signal generator for generating an I mode signal and a Q mode signal and a modulator for modulating signals generated by the baseband signal generator. Further, the test device 210 can renew a type of a parameter to be calibrated and a calibration value by receiving a calibration parameter from the calibration apparatus 220. Furthermore, when a calibration operation is completed, calibration parameters optimizing the test device are finally determined, and values of the calibration parameters are generated in the calibration apparatus as calibration data and transmitted to the test device. The test device 210 can generate a signal for the calibration and transmit the generated signal.

When the test device 210 includes its own signal analyzing module, test device 210 analyzes a target signal component of removal by analyzing the generated signal for the calibration. Further, the test device 210 calculates parameters such as a center frequency and a size of the target signal component of removal and transmits the calculated parameters to the calibration apparatus 220.

Meanwhile, when the test device 210 generates the test signal for testing capability of the DVB-H system after the calibration is completed, a more accurate test signal can be generated using calibration data.

The calibration apparatus 220 grasps a changed value of the calibration parameter such as the size of the target signal component of removal received from the test device 210 and controls the calibration parameter in a direction of reducing the size of the target signal component of removal. When the calibration apparatus 220 includes the signal analyzing module, the calibration apparatus 220 can directly receive the signal for the calibration generated by the test device 210, analyze the received signal, and extract the center frequency and the size of the target signal component of removal. The target signal component of removal is included in the signal for the calibration of the test device for the DVB-H system, and generally may include a component due to carrier leakage and a spurious signal component.

A generated spurious signal component mainly corresponds to a sideband suppression signal or an image suppression signal.

In general, the DVB-H system 230 is a portable device capable of receiving digital broadcasting, and may include a mobile phone and the like providing a function of receiving terrestrial digital broadcasting.

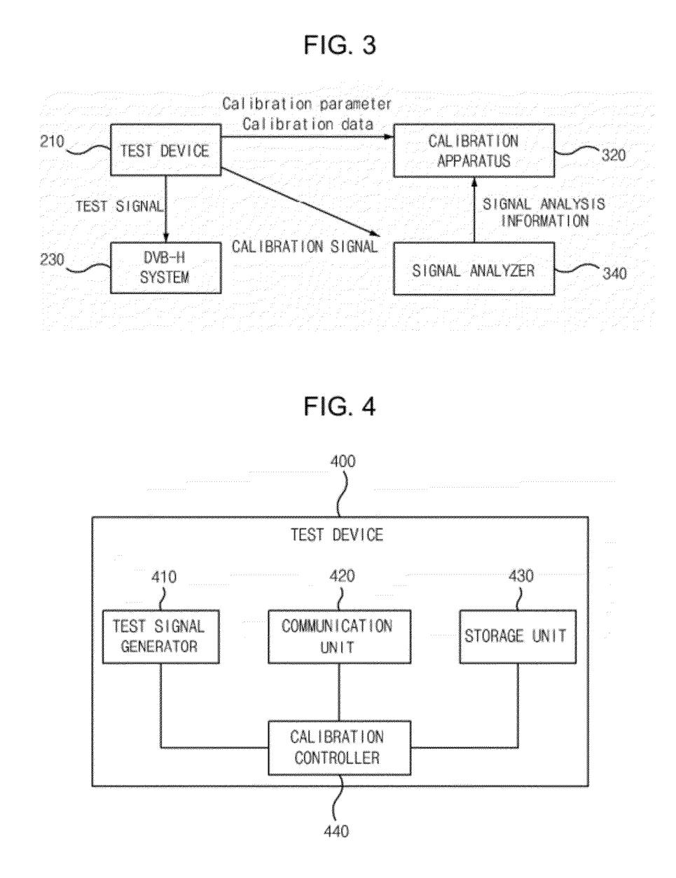

FIG. 3 illustrates a calibration system of the test device for the DVB-H system according to another embodiment of the present invention.

As shown in FIG. 3, the calibration system may include a separate signal analyzer 340. The signal analyzer 340 analyzes signals received from a test device 310. When the test device 310 receives a signal for the calibration, the signal analyzer 340 receives the signal, extracts parameters such as a center frequency and a size of a target signal component of removal, and transmits signal analysis information to the calibration apparatus 320. The calibration apparatus 320 grasps a change in the size of the target signal component of removal through the received signal analysis information, controls the calibration parameters in a direction of reducing the size of the target signal component of removal, and transmits the controlled calibration parameters to the test device 310.

The signal analyzing module may be included in the test device or the calibration apparatus, or a separate signal analyzing device having a function of the signal analyzing module may be connected to the test device and the calibration apparatus.

FIG. 4 illustrates a test device according to an embodiment of the present invention.

As shown in FIG. 4, a test device 400 may include a test signal generator 410, a communication unit 420, a storage unit 430, and a calibration controller 440.

The test signal generator 410 generates a signal for the calibration for performing the calibration of the test device 400 and generates a test signal for testing a capability of the DVB-H system and the like.

The test signal generator 410 can generate a calibrated signal by controlling parameters such as a gain, an offset and the like according to a control of the calibration controller 440.

The communication unit 420 receives a calibration parameter or calibration data from the calibration apparatus and transmits the signal for the calibration generated by the test signal generator 410. Besides, the communication unit 420 performs a function of transmitting/receiving various types of wired and wireless data.

The storage unit 430 stores various types of data including the calibration data and provides the stored calibration data to the test signal generator 410 according to a control of the calibration controller 440.

When the calibration parameter is received through the communication unit 420, the calibration controller 440 controls the parameters such as the gain of the test signal generator, the offset and the like according to the received calibration parameter. Further, the calibration controller 440 controls such that the test signal generator 410 generates the signal for the calibration based on the controlled calibration parameter and the generated signal for the calibration is transmitted through the communication unit 420. When the communication unit 420 receives the calibration data, the calibration controller 440 controls such that the calibration data is stored in the storage unit 430.

When the test signal generator 410 generates the test signal, the calibration controller 440 controls such that the parameters such as the gain and the offset are controlled using calibration data distinguished for each frequency.

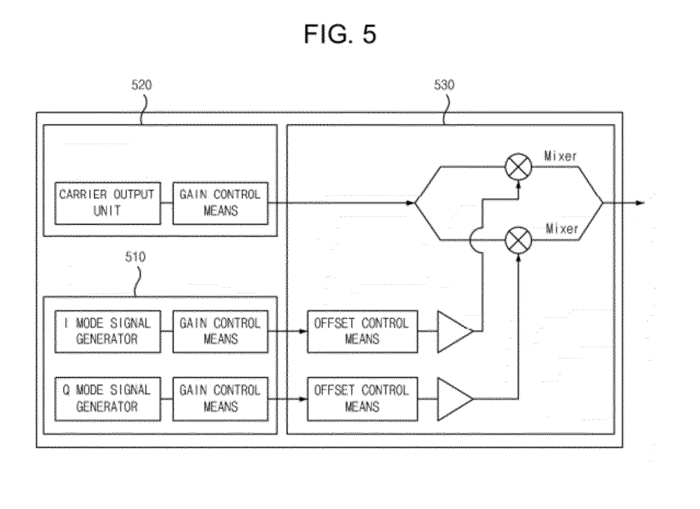

FIG. 5 illustrates a detailed construction of a test device according to an embodiment of the present invention.

As shown in FIG. 5, the test device 500 may include a baseband signal generator 510, a carrier output unit 520, and a test signal modulator 530.

The baseband signal generator 510 includes a gain control means for controlling a gain of each signal, the gain control means including an I mode signal generator and a Q mode signal generator. The carrier output unit 520 includes a gain control means for controlling a gain of a carrier. The test signal modulator 530 includes an offset control means of the I and Q mode signals and an IQ modulator.

Calibration items of the test device include a frequency calibration, an output power level calibration, an IQ modulation calibration, a modulation carrier calibration and the like. Among the above calibrations, the IQ modulation calibration is the most important factor to determine a quality of the test signal.

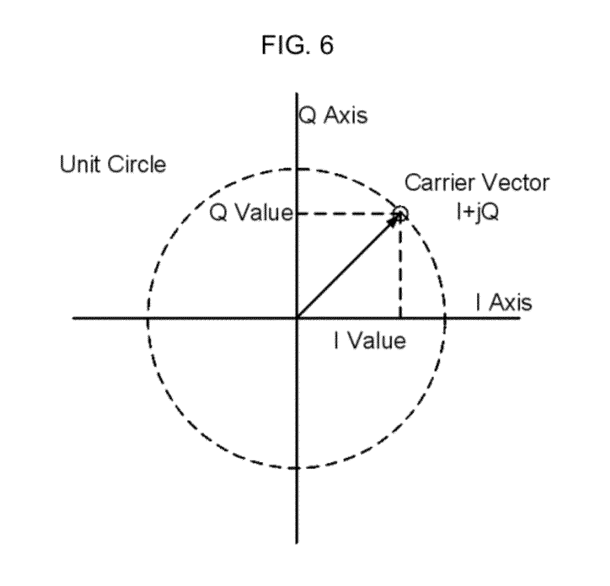

The IQ modulation refers to a modulation of a signal by controlling amplitudes and phases of two quadrature signals in I and Q modes. FIG. 6 illustrates a test signal generated by an ideal modulator.

However, a circuit of an actual test device does not perform an ideal IQ modulation because of various causes and does not output a desired test signal. Among the various causes, there is a gain difference between the I mode signal the Q mode signal, carrier leakage of the modulator, a phase error and the like as main causes. Due to such causes, respective manufactured test devices have different errors and show different characteristics according to frequency changes, which makes it difficult to secure the reliability of the test device.

Accordingly, a calibration process is required to achieve the ideal modulation, and the ideal modulation can be obtained through proper gain control, phase control, and offset control.

Hereinafter, the calibration process will be described in detail.

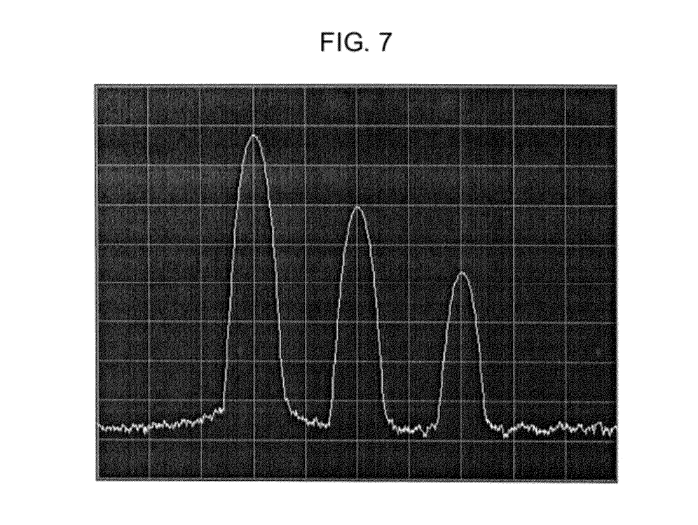

A signal for the calibration generated in the test device to calibrate the test device is as shown in FIG. 7. A projecting signal (lobe) formed in a center is a target signal component of removal due to the carrier and a lobe formed in a right side is also a target signal component of removal as a spurious signal. When only a signal component (lobe) in the left-most side exists after all target signal components of removal are removed by calibrating the signal for the calibration, the calibration is completed. Calibration parameters for minimizing a size of a target signal component of removal are stored as calibration data and transmitted to the test device.

In order to minimize the target signal component of removal due to the carrier (due to the carrier leakage) located in the center, it is required to control offsets of the I mode signal and the Q mode signal. Preferably, an I mode signal offset parameter minimizing the size of the target signal component of removal due to the carrier by controlling the offset (I offset) of the I mode signal can be calculated and then a Q mode signal offset parameter minimizing the size of the target signal component of removal due to the carrier by controlling the offset (Q offset) of the Q mode signal can be calculated.

In order to remove a spurious signal located in the right-most side, it is required to control gains of the I mode signal and the Q mode signal and phase angles (theta) of the I mode signal and the Q mode signal. Preferably, a value of the calibration parameter minimizing the size of the spurious signal can be found by controlling parameters according to an order of the I mode signal gain (I gain), the Q mode signal gain (Q gain), and the phase angle.

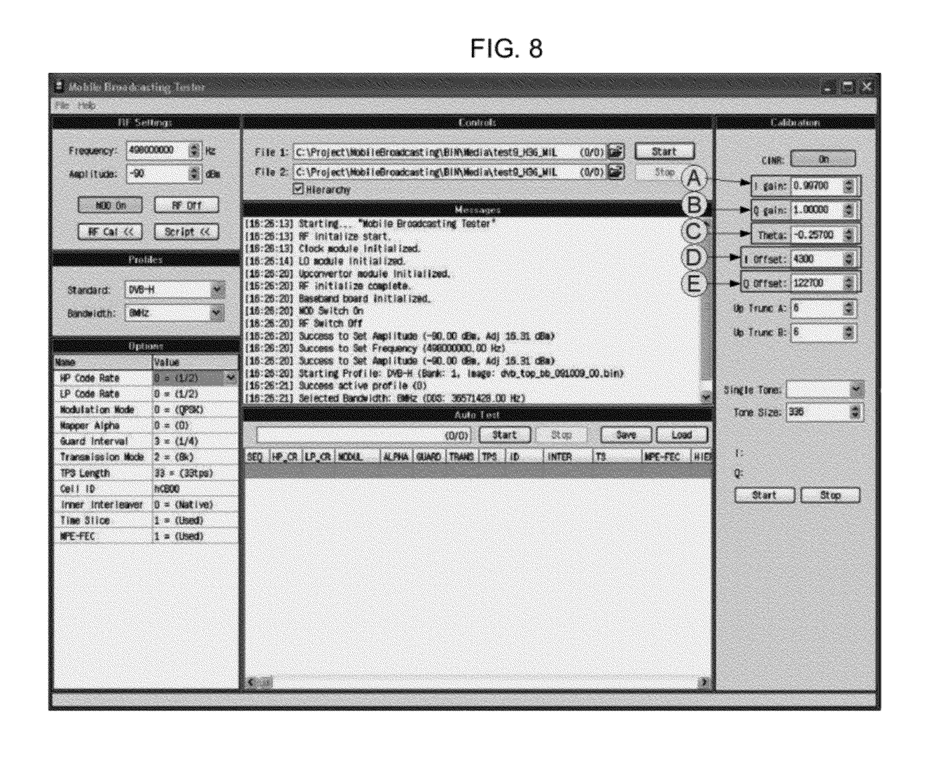

FIG. 8 illustrates an embodiment of a GUI of an automatic calibration program installed in the calibration apparatus. As shown in FIG. 8, calibration parameters used for the IQ calibration may include I gain, Q gain, theta, I offset, and Q offset.

In an upper left part of FIG. 8, a window for setting a frequency and an amplitude with which the calibration can be performed is set. In order to secure a frequency identity in various frequency bands, it is preferable that the IQ calibration is repeatedly performed with different frequencies and calibration data is secured for each frequency. Further, in the center of a left part of FIG. 8, a window for setting a system to be tested is set. As shown in FIG. 8, DVB-H can be selected and a bandwidth can be set to test the capability of the DVB-H system. Since each system has a different characteristic, a frequency band and a type of calibration with which the calibration is performed may vary.

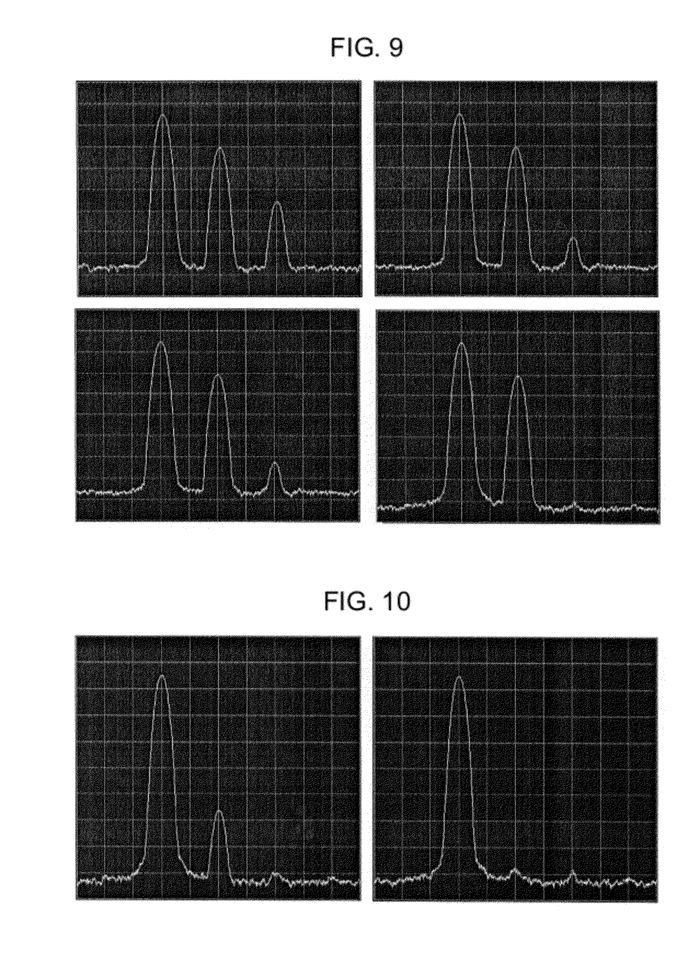

FIG. 9 illustrates the calibration performed by receiving a signal for the calibration.

The signal for the calibration transmitted by the test device is analyzed by the signal analyzing module, and is illustrated in FIG. 9 with extraction of target signal components of removal. In each of four graphs of FIG. 9, there are three projecting signal components (lobes). A lobe located in the right-most side is a spurious signal which is one of the target signal components of removal, a lobe located in the center is a target signal component of removal due to the carrier (or a target signal component of removal due to the carrier leakage), and a lobe located in the left-most side is a signal component generated in the baseband. Center frequencies of respective signal components are spaced apart from each other at intervals of about 400 kHz.

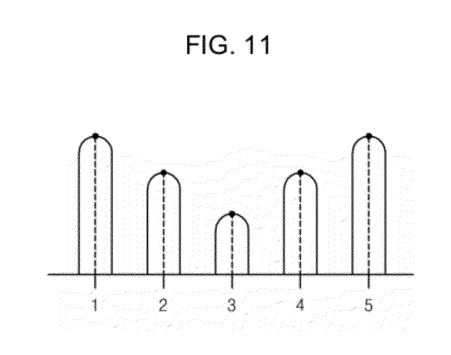

In the calibration process, it is preferable to first remove the target signal component of removal due to the carrier leakage rather than first remove the spurious signal. That is, in order to perform an operation of minimizing a size of the central lobe, it is preferable to first control the I offset and then the Q offset. The operation is illustrated in FIG. 10.

The I offset is controlled as follows. First, when the target signal component of removal is extracted from the signal for the calibration, the size of the target signal component of removal due to the carrier is stored. Next, the I offset is increased or decreased in a predetermined unit and then transmitted to the test device. Then, a signal for the calibration generated by controlling the I offset is received from the test device, the target signal component of removal is extracted, the size of the target signal component of removal due to the carrier is extracted, and the extracted size is stored. Next, a changed value is extracted by comparing the size of the target signal of removal due to the carrier stored after being extracted from the previous signal for the calibration and the size of the target signal of removal due to the carrier extracted from the signal for the calibration in which the I offset has been controlled.

When the changed value has a positive value (+), it is considered that the size of the target signal of removal due to the carrier is increased and thus an increase/decrease direction of the I offset is changed.

When the changed value of the size of the target signal of removal due to the carrier has a negative value (−), it is considered that the size of the target signal of removal is decreased and thus the increase/decrease direction of the I offset is changed in the same direction and then the I offset is transmitted to the test device.

Through repetition of the process, when the size of the target signal of removal due to the carrier arrives within a range of an expected minimum value as shown in a right side of FIG. 9, a fine control is performed by reducing an increase/decrease unit of the I offset. For example, when the increase/decrease unit of the I offset is 10,000 and it is determined that the size of the target signal of removal due to the carrier arrives within the range of the expected minimum value, the fine control of the I offset can be performed by reducing the increase/decrease unit of the I offset to 1000. The control of the increase/decrease unit can be performed through a plurality of controls. In this case, it is possible to perform a more fine control.

The control of the Q offset is performed in the same way as the control of the I offset, and can be performed only after the control of the I offset is completed. Only when the controls of the I offset and the Q offset are completely performed, the size of the target signal of removal due to the carrier can be controlled to have an approximate value to 0 as shown in a right side of FIG. 9.

Next, a method of removing the spurious signal is described with reference to FIG. 9. A process of the method is illustrated in FIG. 9.

A process of minimizing the size of the spurious signal is performed through controls of parameters such as I gain, Q gain, and theta. Any calibration parameter (I gain, Q gain, and theta) can be first controlled, but an order of I gain, Q gain, and theta is followed for convenience. Since a calibration process is the same as the process of minimizing the target signal of removal due to the carrier, its detailed description will be omitted. Only when the controls of I gain, Q gain, and theta are completely performed, the size of the spurious signal can be controlled to have an approximate value to 0 as shown in a right end of FIG. 10.

When the signal for the calibration is first received, it is preferable that basic values of I gain and Q gain are 1, initial control units of I gain and Q gain are controlled to become 0.01, and a fine control is performed in the unit of 0.001.

Five calibration parameters (I gain, Q gain, theta, I offset, and Q offset) are repeatedly controlled and then provided to the test device. Through a repetitive process, by the test device, of again generating the signal for the calibration to which the controlled calibration parameter is applied and transmitting the generated signal, final control values of the five calibration parameters for achieving the optimal calibration are obtained for a particular frequency. The obtained final control values of the five calibration parameters and a corresponding frequency value are stored as calibration data.

It is preferable that the calibration method is repeatedly performed in the unit of 5 MHz in a frequency band of 250 MHz to 2700 MHz in the test device for the DBV-H system. For more precise calibration, the calibration can be performed in the unit of 1 MHz for the entire frequency bands.

Since such a calibration operation requires long hours and a control of large amounts of calibration parameters, it is not possible to perform the calibration operation manually. Accordingly, the calibration apparatus performs the calibration while automatically changing a frequency value within a corresponding frequency band and a calibration parameter according to the aforementioned algorithm, and finally generates the calibration data for the corresponding frequency band.

Although FIGS. 9 and 10 illustrate the method of first removing the spurious signal, it is preferable to first remove the target signal of removal due to the carrier and then remove the spurious signal as described above.

Next, an algorithm for determining whether the size of the target signal component of removal arrives within a range of an expected minimum value will be described.

FIG. 11 illustrates a change in a target signal component of removal based on a control of a calibration parameter.

During the calibration, the calibration apparatus measures the size of the target signal component of removal, controls the calibration parameter, and transmits the controlled calibration parameter to the test device. Then, the calibration apparatus again receives a signal for calibration to which the controlled calibration parameter is applied and again measures the size of the target signal component of removal.

As shown in FIG. 11, when a size of a target signal component of removal of a signal for calibration which is thirdly received is a minimum and sizes of target signal components of removal of signals after the signal which is thirdly received are increased, it is determined that the size of the signal component arrives within the expected minimum value when the calibration parameter for generating the thirdly received signal for calibration is applied. At this time, the above calibration process is again performed after the calibration parameter for generating the thirdly received signal for calibration is set to have an initial value and an increase/decrease range of the calibration parameter is reduced, so that another expected minimum value can be obtained. In this step, since a control unit of the calibration parameter is tiny, it is possible to achieve more precise calibration. Here, more precise calibration parameter value can be obtained by repeatedly performing a fine control process with a tinier unit of the calibration parameter, but it is preferable to perform the fine control process only once in an aspect of the efficiency. Further it is preferable to properly select a primary increase/decrease unit and a secondary increase/decrease unit in an aspect of reducing the total number of calculation measurements and shortening the time.

While the detailed description of the present invention has described certain exemplary embodiments such as a portable terminal, it will be understood by those skilled in the art that various changes in form and details may be made therein without departing from the spirit and scope of the invention as defined by the appended claims.

1. A method of calibrating a test device for a wireless communication system performed by a calibration apparatus, the method comprising the steps of:
(a) extracting a size of a target signal component of removal based on a signal for a calibration generated in the test device;
(b) extracting a changed value of the size of the target signal component of removal;
(c) controlling one or more calibration parameters based on the changed value and transmitting values of the controlled calibration parameters to the test device; and
calculating a calibration parameter value minimizing the size of the target signal component of removal through repetition of the steps of (a) to (c), and generating the calculated calibration parameter value as calibration data.

2. The method as claimed in claim 1, wherein the step of (a) comprises directly extracting the size of the target signal component of removal from the signal for the calibration by receiving the signal for the calibration generated in the test device, or extracting the size of the target signal component of removal from an analysis signal transmitted by a signal analyzing device receiving the signal for the calibration generated in the test device.

3. The method as claimed in claim 1, wherein the target signal component of removal includes a signal component due to carrier leakage or a spurious signal component and the size of the target signal component of removal includes a size of the signal component due to the carrier leakage or a size of the spurious signal component, wherein minimizing the size of the target signal component of removal corresponds to minimizing the size of the signal component due to carrier leakage or the size of the spurious signal component.

4. The method as claimed in claim 3, further comprising generating a calibration data for each frequency by repeatedly performing the calibration in every predetermined frequency unit for entire frequency bands related to a test of the test device, and transmitting the calibration data for each frequency to the test device.

5. The method as claimed in claim 3, wherein the calibration includes an IQ calibration, and the calibration parameter includes two or more parameters of a gain control parameter of an I mode signal, a gain control parameter of a Q mode signal, a phase angle control parameter of a baseband signal, an offset control parameter of the I mode signal, and an offset control parameter of the Q mode signal.

6. The method as claimed in claim 3, wherein the wireless communication system is a DVB-H system, and the calibration is an IQ calibration.

7. The method as claimed in claim 3, wherein the step of (c) comprises:
determining whether the size of the target signal component of removal arrives within an approximate value of an expected minimum value;
deciding an increase/decrease direction of the calibration parameter as a direction in which the size of the target signal component of removal is decreased, based on the changed value; and
increasing or decreasing the calibration parameter according to the decided increase/decrease direction for each predetermined unit,
wherein, when the size of the target signal component of removal arrives within the approximate value of the expected minimum value, an increase/decrease unit of the calibration parameter is reduced so that a precise control of the calibration parameter is achieved.

8. The method as claimed in claim 3, wherein minimizing the target signal component of removal comprises minimizing the spurious signal component by controlling an offset control parameter of an I mode signal and an offset control parameter of a Q mode signal and then minimizing a signal component due to carrier leakage by controlling a gain control parameter of the I mode signal, a gain control parameter of the Q mode signal, and a phase angle control parameter of an IQ baseband signal.

9. A test device for a wireless communication system, the test device comprising:
a test signal generator for generating a signal for a calibration used for the calibration of the test device and a capability test signal used for testing capability of the wireless communication system;
a communication unit for transmitting the signals generated by the test signal generator to an outside and receiving calibration data calculated for each predetermined frequency;
a storage unit for storing the calibration data; and
a calibration controller for calibrating the test signal generator by using the calibration data.

10. The test device as claimed in claim 9, wherein the test signal generator comprises:
a baseband signal generator for generating an I mode signal and a Q mode signal; and
a test signal modulator for generating a test signal for the calibration by modulating the I mode signal and the Q mode signal.

11. The test device as claimed in claim 10, wherein the calibration controller comprises:
a calibration parameter extractor for extracting a calibration parameter for a corresponding frequency from the stored calibration data;
a gain controller for controlling a gain of the I mode signal and a gain of the Q mode signal by using the extracted calibration parameter; and
an offset controller for controlling an offset of the I mode signal and an offset of the Q mode signal by using the extracted calibration parameter.

12. The test device as claimed in claim 11, wherein the wireless communication system is a DVB-H reception apparatus.

13. A computer readable medium recording a program for executing the calibration method as claimed in claim 1.

14. A method of manufacturing a test device capable of performing a calibration for each corresponding frequency, the method comprising the steps of:
manufacturing a test device;
(a) generating a signal for a calibration by using the test device, and transmitting the signal to a calibration apparatus;
generating calibration data by using the calibration apparatus; and
storing the calibration data in the test device to optimize the test device.

15. The method as claimed in claim 14, wherein generating of the calibration data comprises the steps of:
(b) extracting a size of a target signal component of removal from the signal for the calibration generated in the test device by using the calibration apparatus;
(c) extracting a changed value of the size of the target signal component of removal by using the calibration apparatus;
(d) controlling one or more calibration parameters based on the changed value, and transmitting values of the controlled calibration parameters to the test device; and
calculating a calibration parameter value optimizing the size of the target signal component of removal, by using the calibration apparatus and the test device through repetition of the steps of (a) to (d), and generating the calculated calibration parameter value as calibration data.

16. A method of manufacturing a test device for a wireless communication system through transmission of the calibration data generated using the calibration method as claimed in claim 1 to a test device for a wireless communication system.

17. The calibration method as claimed in claim 1, wherein the spurious signal component is a sideband suppression signal or an image suppression signal.
